(19) United States
(12) Patent Application Publication
(10) Pub. No.: US 2022/0222576 A1
(43) Pub. Date: Jul. 14, 2022

(54) DATA GENERATION APPARATUS, METHOD AND LEARNING APPARATUS

(71) Applicant: KABUSHIKI KAISHA TOSHIBA, Tokyo (JP)

(72) Inventors: Masahiro ITO, Tokyo (JP); Tomohiro YAMASAKI, Tokyo (JP)

(73) Assignee: KABUSHIKI KAISHA TOSHIBA, Tokyo (JP)

(21) Appl. No.: 17/460,399

(22) Filed: Aug. 30, 2021

(30) Foreign Application Priority Data
Jan. 12, 2021 (JP) 2021-002781

(51) Int. Cl. G06N 20/00; G06F 40/284; G06K 9/62

(52) U.S. Cl. CPC G06N 20/00; G06K 9/6257; G06F 40/284

(57) ABSTRACT

According to one embodiment, a data generation apparatus includes a processor. The processor selects an event group in which at least a part of a plurality of event ranges overlap, the event ranges being ranges of character sequences estimated by a plurality of different methods with respect to a document of teaching data and being different from ranges of character sequences defined with respect to the document. The processor determines, from among the event group, an additional event which is an event range to be added to the teaching data.

### CROSS-REFERENCE TO RELATED APPLICATIONS

This application is based upon and claims the benefit of priority from Japanese Patent Application No. 2021-002781, filed Jan. 12, 2021, the entire contents of which are incorporated herein by reference.

### FIELD

Embodiments described herein relate generally to a data generation apparatus, method and a learning apparatus.

### BACKGROUND

As a task which has been attracting attention in the field of natural language processing, there is known an extraction task of a text range, such as named entity extraction using so-called “sequence labeling”. A data set, in which a label that designates a text range is given in a document in advance, is prepared for machine learning relating to the sequence labeling, but there is a possibility that a label error is included in the data set. In connection with such a data set, there is known a method of reducing the influence of the label error and improving, mainly, a precision at a time of estimating a trained model trained by using the data set, by estimating a sentence which possibly includes a label error and lowering the weight of the sentence including an estimated label error.

However, when a causal relationship extraction task or the like, in which text ranges extracted by sequence labeling are subjected to preprocessing, is executed, it is important to extract all text ranges which may have a causal relationship. Specifically, more importance is placed on a recall which indicates whether labels are correctly given to character sequences to which labels should normally be given, than on the precision which indicates a ratio of correctness of labels that are given.

Thus, in the above-described method, the weight of a sentence including a label error is merely lowered, and the recall cannot be improved.

### BRIEF DESCRIPTION OF THE DRAWINGS

FIG. 1 is a block diagram illustrating a data generation apparatus according to an embodiment.

FIG. 2 is a view illustrating an example of teaching data which is stored in a teaching data storage.

FIG. 3 is a flowchart illustrating an example of an event generating process of the data generation apparatus.

FIG. 4 is a view illustrating an example of use of partial data of a first time of k-fold cross validation.

FIG. 5 is a view illustrating an example of use of partial data of a second time of k-fold cross validation.

FIG. 6 is a view illustrating an example of a generation method of event groups.

FIG. 7 is a view illustrating an example in which a candidate group is selected from among event groups.

FIG. 8 is a view illustrating an example of a decision of an additional event.

FIG. 9 is a view illustrating an example of use of event ranges.

FIG. 10 is a view illustrating an example in a case where an additional event is added by the data generation apparatus.

FIG. 11 is a view illustrating an example of a hardware configuration of the data generation apparatus.

### DETAILED DESCRIPTION

In general, according to one embodiment, a data generation apparatus includes a processor. The processor selects an event group in which at least a part of a plurality of event ranges overlap, the event ranges being ranges of character sequences estimated by a plurality of different methods with respect to a document of teaching data and being different from ranges of character sequences defined with respect to the document. The processor determines, from among the event group, an additional event which is an event range to be added to the teaching data.

Hereinafter, a data generation apparatus, a data generation method and a learning apparatus according to embodiments will be described with reference to the accompanying drawings. Note that in the embodiments below, parts denoted by identical reference signs are assumed to perform similar operations, and an overlapping description is omitted unless where necessary.

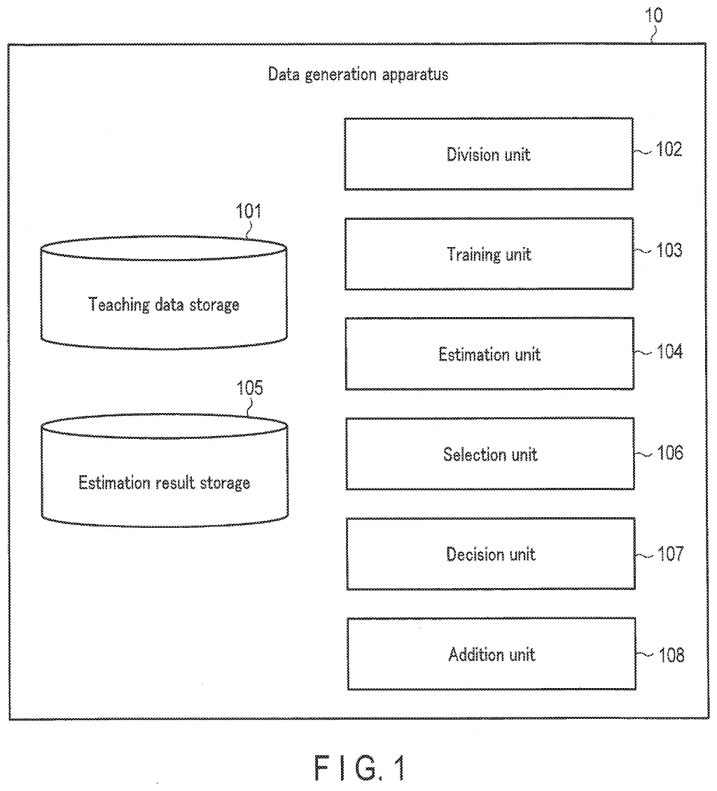

A data generation apparatus according to an embodiment will be described with reference to a functional block diagram of FIG. 1.

A data generation apparatus 10 according to the embodiment includes a teaching data storage 101, a division unit 102, a training unit 103, an estimation unit 104, an estimation result storage 105, a selection unit 106, a decision unit 107, and an addition unit 108. Note that a combination of the teaching data storage 101 and the training unit 103 is also referred to as “learning apparatus”.

The teaching data storage 101 stores teaching data. The teaching data is a data set in which a document including a plurality of sentences is correlated with text ranges (hereinafter referred to as “event ranges”) which are arbitrarily designated to character sequences included in the document. The “event” in the embodiment means an event indicated in the document. The event range is assumed to be, for example, a range of a character sequence indicative of a cause or a result of a trouble. However, the event range is not limited to an event, and may be an arbitrary text range designated for other purposes, for example, by designation of a named entity. The event ranges of the data set may be given, for example, manually.

The division unit 102 receives the teaching data stored in the teaching data storage 101, and divides the teaching data into a plurality of partial data. In the embodiment, for example, it is assumed that k-fold cross validation (k is a positive number of 2 or more) is executed, and the division unit 102 divides the teaching data into a k-number of partial data. In addition, the division unit 102 generates a plurality of sets of a plurality of partial data, by varying division positions in the teaching data.

The training unit 103 trains a model by using the teaching data, and generates a trained model. The training unit 103 trains the model by using, for example, one of the k-number of partial data as data for inference, and the other of the (k−1) number of partial data as training data, and generates a k-number of trained models. Further, the training unit 103 uses the k-number of trained models as one set, and generates trained models for each of sets of k-number of partial data. Note that the k-number of trained models generated in accordance with one set of a plurality of partial data are also referred to as one trained model set.

The estimation unit 104 estimates event ranges in the document of the teaching data, for each of a plurality of different trained model sets trained by using the teaching data.

The estimation result storage 105 stores the event ranges estimated by the estimation unit 104, as labels indicative of ranges of corresponding character sequences in a document, by correlating the event ranges with the document.

The selection unit 106 selects an event group in which at least a part of a plurality of event ranges overlap, the event ranges being estimated by a plurality of different methods with respect to the document of the teaching data and being different from an event range already defined(predefined) in the teaching data. The plurality of event ranges estimated by the different methods refer to, for example, a plurality of event ranges estimated by the estimation unit 104 for each of the trained model sets. Note that, in the different methods, it suffices that the event ranges are estimated multiple times from different viewpoints with respect to the teaching data. In other words, the positions of occurrences of sentences in the document of teaching data may be interchanged, or network structures of the models may be changed, or hyper parameters of the models may be changed, or manual methods may be used as the different methods.

The decision unit 107 decides an additional event which is an event range to be added to the teaching data from the event group.

The addition unit 108 adds the additional event to the teaching data, and registers the additional event (and the teaching data in which the additional event is added) in the teaching data storage 101.

Note that the teaching data storage 101 and the estimation result storage 105 may be provided outside the data generation apparatus 10, for example, as external servers, and it suffices that the data generation apparatus 10 can access, when necessary, the teaching data storage 101 and the estimation result storage 105.

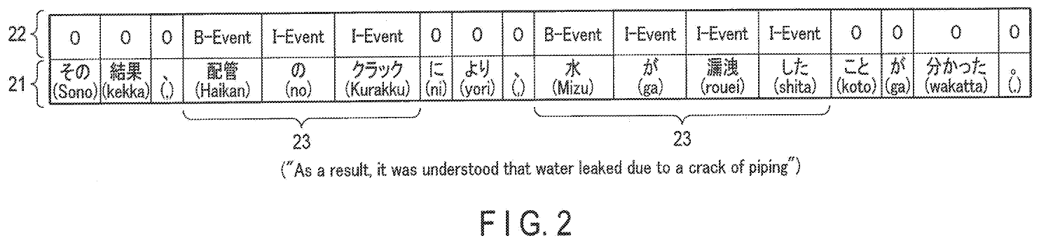

Next, an example of the teaching data stored in the teaching data storage 101 will be described with reference to FIG. 2.

Teaching data illustrated in FIG. 2 is an example in which labels 22 are given to character sequences of a document 21. Specifically, the labels 22 are given to structural units (also called tokens) such as characters or morphemes which constitute the document 21, in a manner to designate event ranges 23. For example, when it is assumed that an event “Haikan no Kurakku” (“crack of piping”) and an event “Mizu ga rouei shita” (“water leaked”) are included in the document 21, labels 22 of “B-Event”, “I-Event” and “O” are given to morphemes constituting the document 21, that is, “Sono/kekka/,/Haikan/no/Kurakku/ni/yori/,/Mizu/ga/rouei/shita/koto/ga/wakkata/./” (“As a result, it was understood that water leaked due to a crack of piping”), and the event ranges 23 are designated. To be more specific, “B-Event/I-Event/I-Event” are given, respectively, to the morphemes “Haikan/no/Kurakku” (“crack/of/piping”), and the event range 23, “Haikan no Kurakku” (“crack of piping”), is defined. Similarly, the event range 23, “Mizu ga rouei shita” (“water leaked”), is defined.

The “B-event” is indicative of a beginning position of an.event in the document 21. The “I-Event” is indicative of an element which constitutes the event and follows the structural unit to which the “B-event” is given. “O” is indicative of an element which does not constitute the event, i.e. an element outside the event range.

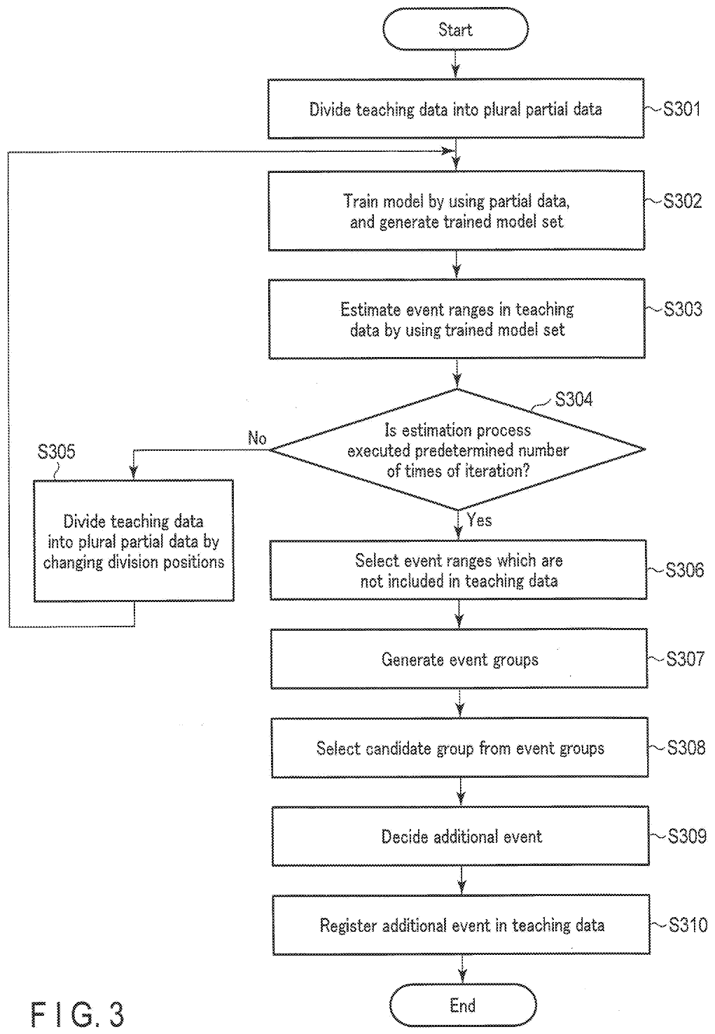

Next, an example of an additional event generation process of the data generation apparatus 10 according to the embodiment will be described with reference to a flowchart of FIG. 3.

In step S301, the division unit 102 divides teaching data into a plurality of partial data. In a division method of teaching data, for example, the teaching data may be divided into a k-number of partial data in order to execute k-fold cross validation. Note that, aside from the k-fold cross validation, any method can be adopted which generates proper partial data such that a plurality of trained model sets can be generated.

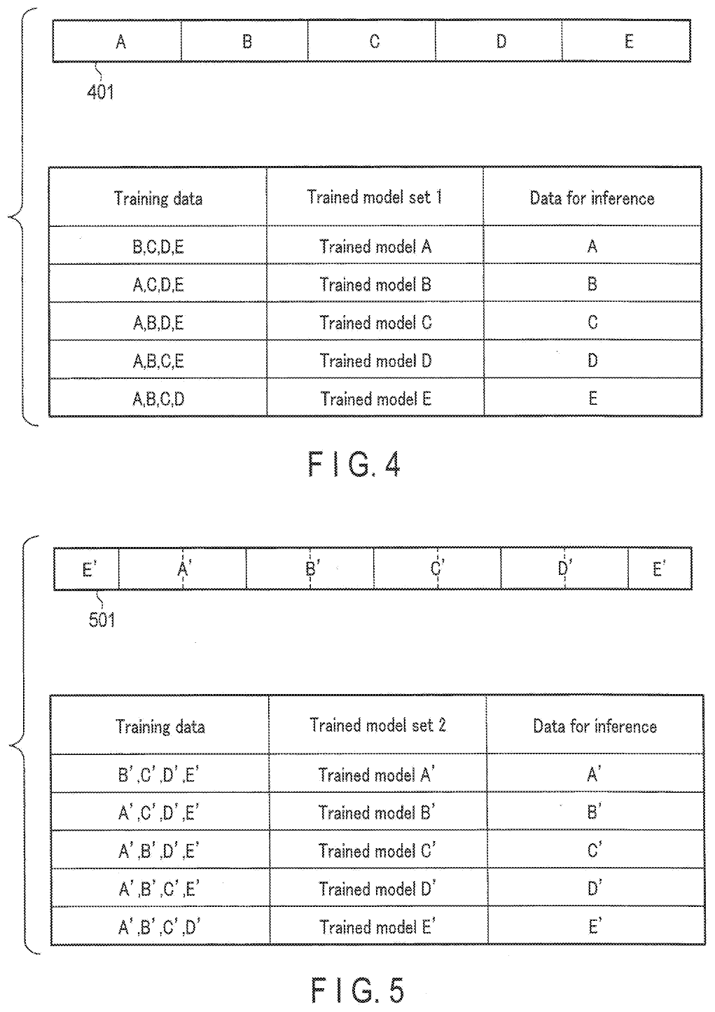

In step S302, the training unit 103 trains models by using the plurality of partial data, and generates a one trained model set including a plurality of trained models. The training process in the training unit 103 will be described later with reference to FIG. 4 and FIG. 5.

In step S303, the estimation unit 104 estimates event ranges included in the document of the teaching data by using the trained model set. The estimated event ranges are stored in the estimation result storage 105.

In step S304, it is determined whether the estimation unit 104 has executed, by a predetermined number of times of iteration, the estimation process of the event ranges using the trained model set in step S303. Specifically, for example, a counter is set, and the value of the counter is incremented by 1 each time the estimation process of the event ranges of step S303 is executed, and it may be determined whether or not the value of the counter agrees with the predetermined number of times of iteration. When the estimation process of the event ranges has been executed by the predetermined number of times of iteration, the process goes to step S306. When the estimation process of the event ranges has not been executed by the predetermined number of iteration, the process goes to step S305.

In step S305, the division unit 102 divides the teaching data once again into a plurality of partial data at division positions which are different from the previous division positions. Then, the process goes to step S302, and the same process is repeated.

In step S306, the selection unit 106 compares the event ranges, which are estimated for the respective trained model sets, between the trained model sets. The selection unit 106 selects, as a result of the comparison, event ranges which are not included in the teaching data.

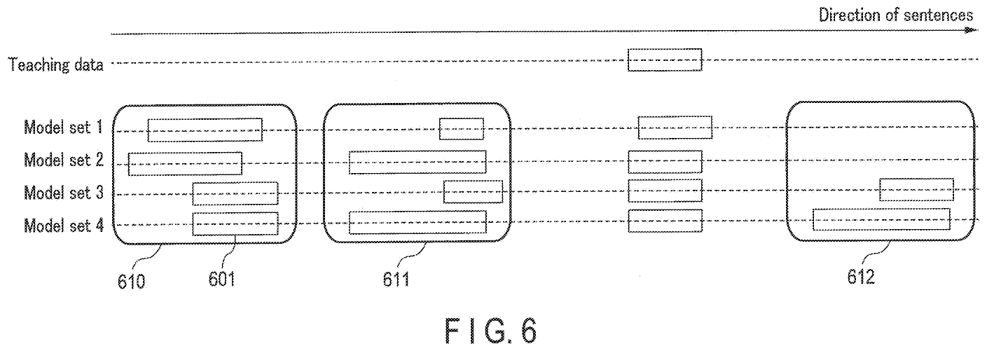

In step S307, the selection unit 106 generates at least one event group in which a plurality of event ranges selected in step S306 are grouped. For example, a plurality of event ranges having an overlapping degree of a threshold or more are collected as an event group. Note that the details of the event group generation process of step S306 and step S307 will be described later with reference to FIG. 6.

In step S308, the selection unit 106 selects, from one or more event groups, at least one candidate group having higher certainty not as an estimation error but as an omission in teaching data.

In step S309, the decision unit 107 determines an additional event which is to be added to the teaching data, from among one or more candidate groups selected in step S308.

In step S310, the addition unit 108 adds the determined additional event to the teaching data, and registers the determined additional event in the teaching data storage 101. Specifically, the teaching data stored in the teaching data storage 101 is updated. Note that the teaching data that is updated is also referred to as “updated teaching data”.

Next, referring to FIG. 4 and FIG. 5, a description will be given of the training of a model using a plurality of partial data and the estimation of an event using a trained model in step S301 to step S303.

An upper part of FIG. 4 illustrates a conceptual view of partial data for teaching data, and a lower part of FIG. 4 is a table illustrating allocation of partial data used for the training and the inference.

In the embodiment, it is assumed that 5-fold cross validation is executed. Specifically, in the upper part of FIG. 4, the teaching data is divided into five partial data 401, i.e. partial data “A” to partial data “E”. Here, as regards the five partial data 401, four partial data 401 are used as training data, and the other one partial data 401 is used as data for inference. For example, when the teaching data is a document composed of 10,000 sentences, the teaching data may be divided into five partial data each being composed of 2,000 sentences, and 8,000 sentences may be used as training data and 2,000 sentences may be used as data for inference.

Specifically, as illustrated in the lower part of FIG. 4, when partial data “B, C, D, E” are used as training data, a model is trained by using the four partial data of the training data “B, C, D, E”, and the other partial data A is used as data for inference “A”. As the training method of the model, an existing method may be used. For example, the model is trained by using only the document in the training data “B, C, D, E” as input data, and using a set of the document of the training data “B, C, D, E” and labels given to the document as correct answer data. A difference between the output data from the model in regard to the input data and the correct answer data is evaluated by an error function, and a back-propagation process is executed so as to minimize the error function, thereby generating a trained model. Here, for the purpose of convenience of description, the trained model for inferring the data for inference A is referred to as “trained model A”. The estimation unit 104 estimates an event range included in the data for inference A, by using the trained model A.

Next, when the training data are changed and “A, C, D, E” are used as training data, a model is trained by using four partial data of the training data “A, C, D, E”, and a trained model B is generated like the trained model A. The estimation unit 104 estimates an event range included in the data for inference “B”, by using the trained model B.

In this manner, the training data and the data for inference are successively changed such that all partial data are allocated as data for inference, and the estimation process of event ranges by the trained models is executed. As a result, by the event range estimation process from the trained model A to the trained model E, the estimation process of the event ranges for the entire document of the teaching data can be executed once.

Note that, here, the five trained models, i.e. the trained model A to the trained model E illustrated in FIG. 4, are collectively referred to as “trained model set 1”. In the example of FIG. 4, a first estimation process of event ranges is executed by using the trained model set 1.

Next, FIG. 5 illustrates a case in which the division unit 102 divides the teaching data at positions different from the division positions of the teaching data in the upper part of FIG. 4.

An upper part of FIG. 5 is a conceptual view of partial data, which is similar to the upper part of FIG. 4, but the teaching data is divided at positions different from the positions in the upper part of FIG. 4. Broken lines indicate the division positions illustrated in the upper part of FIG. 4, and solid lines indicate new division positions. For example, a first part of the teaching data is a part of partial data “E′”. In this manner, a plurality of partial data “A′, B′, C′, D′, E′” are newly generated.

A lower part of FIG. 5, like the lower part of FIG. 4, is a table illustrating allocation of partial data used for the training and inference. The training unit 103 and estimation unit 104 execute a similar process to the process in the case of FIG. 4, in regard to the training of the models and the estimation of the event ranges using the trained models. As a result, by a trained model set 2 “A′, B′, C′, D′, E′”, a second estimation process of event ranges is executed for the entire document of the teaching data.

Since the document is divided at the different positions, the case of FIG. 4 and the case of FIG. 5 are different with respect to the set of sentences (character sequences) included in the partial data. Thus, the trained models, which are the results of training using the partial data, are also different between the case of FIG. 4 and the case of FIG. 5. In this manner, the division unit 102 generates a plurality of sets of a plurality of partial data with different division positions, and thereby k-fold cross validation can be executed multiple times, and a fluctuation of estimation results among trained models can be equalized.

Note that in the examples of FIG. 4 and FIG. 5, it is assumed that the contents of partial data in each time of the estimation process of event ranges are changed by varying the division positions in the teaching data, but the embodiment is not limited to this. For example, partial data may be generated after randomly rearranging sentences of the teaching data in each time of the estimation process of event ranges, without changing the division positions for the teaching data. Specifically, any kind of generation method of partial data may be adopted if sentences included in partial data are made different in respective times of the estimation process of event ranges.

Furthermore, if the estimation process of event ranges is executed multiple times for the entire document of the teaching data, the embodiment is not limited to the case in which the k-fold cross validation by partial data is executed multiple times. For example, models having a plurality of different network structures are trained in advance by other training data or the like, and the estimation process of event ranges may be executed for the entire document of the teaching data by using trained models of different network structures. For example, different estimation results of event ranges can be obtained by executing the estimation process of event ranges by preparing a plurality of models having different network structures, such as an RNN (Recurrent Neural Network) model, an LSTM (Long Short-Term Memory) model, a Transformer model, and a BERT model.

Besides, a plurality of different trained models may be generated by training a certain model by varying hyper-parameters such as the number of layers of a neural network, the number of units, an activation function, and a dropout ratio. Since the hyper-parameters are different, it is considered that output results of trained models are also different to some extent. Thus, a plurality of different estimation results of event ranges can be obtained.

Furthermore, results of manual setting of event ranges by a plurality of users with respect to the document of teaching data may be used. Since it is considered that ranges recognized as event ranges vary from user to user, different estimation results of event ranges can be obtained.

Next, a generation method of an event group will be described with reference to FIG. 6.

FIG. 6 illustrates event ranges obtained by multiple times of the estimation process of event ranges by using trained model sets (in FIG. 6, simply referred to as “model sets”). A horizontal direction in FIG. 6 indicates a direction of progress of sentences in the document of teaching data. A vertical direction in FIG. 6 indicates the kinds of trained model sets.

For the purpose of convenience of description, a character sequence is indicated by a broken line, and an event range in the teaching data and event ranges 601 estimated in each model set are illustrated. Here, by way of example, a case is described in which a plurality of partial data were generated four times at different division positions with respect to the teaching data, and the estimation process of event ranges was executed four times by using different trained model sets, i.e. a trained model set 1 to a trained model set 4. Since the trained model sets of the model set 1 to the model set 4 are different, estimated event ranges 601 are different even for the same document.

The selection unit 106 selects an estimated event range which does not occur in the teaching data, from among the event ranges 601 estimated in each model set. In a method of determining whether an event range does not occur in the teaching data, for example, when a range of a character sequence estimated as an event range by a trained model set overlaps even a part of a character sequence of an event range in the teaching data, the selection unit 106 may determine that the estimated event range occurs in the teaching range. On the other hand, when the estimated range of the character sequence does not overlap the event range of the teaching data, the selection unit 106 may determine that the estimated event range does not occur in the teaching range.

In addition, when an overlapping degree between the estimated event range and the event range of the teaching range is less than a threshold, the selection unit 106 may determine that the estimated event range does not occur in the teaching range. Besides, when an n-number (n is a positive number of 1 or more) of morphemes from the end of the estimated event range do not overlap the teaching data, the selection unit 106 may determine that the estimated event range does not occur in the teaching range.

Subsequently, the selection unit 106 collects events with similar event ranges 601, among the event ranges 601 which do not occur in the teaching data, and generates an event group 610.

In a method of determining whether the event ranges 601 are similar or not, event ranges of the respective trained model sets may be transversely compared, and, when one or more characters of the character sequences of the event ranges overlap, it may be determined that the event ranges are similar. Note that when the overlapping degree of the character sequences of the event ranges 601 is a threshold or more, for example, when the overlapping degree is n % or more, it may be determined that the event ranges 601 are similar. Besides, when any of an n-number of morphemes from the end of each of the event ranges 601 is overlapping, it may be determined that the event ranges 601 are similar. Furthermore, these determination methods may be combined, or other determination methods may be adopted.

Note that since third event ranges 601 of the respective model sets along the direction of progress of sentences include ranges overlapping the teaching data, the selection unit 106 does not generate an event group for these event ranges.

In the example of FIG. 6, three event groups 610, 611 and 612, which are groups in which the event ranges estimated in the respective trained model sets overlap, are generated by using the determination method of generating an event group when “one or more characters of character sequences of event ranges overlap”. For example, in the event group 610, the event ranges estimated in the respective trained model sets are not identical character sequences, but include a fluctuation of estimation(inference). The event group 601 will concretely be described, and a case is now assumed in which the respective trained model sets estimate event ranges for, for example, a sentence “Haikan no yousetsu furyo ha nakatta” (“there was no welding defect of piping”). In this case, for example, “Haikan no yousetsu furyo” (“welding defect of piping”) is estimated as the event range 601 in the model set 1, and “furyo ha” (“defect”) is estimated as the event range 601 in the model set 3.

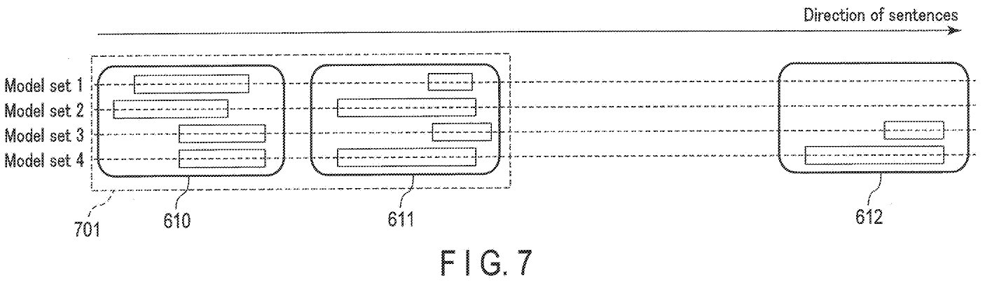

Next, referring to FIG. 7, a description is given of an example in which a candidate group including event ranges that are to be added is selected from an event group.

The selection unit 106 selects, as a candidate group 701, an event group including a number of events, which is a threshold or more. In the example of FIG. 7, for example, when the threshold is set at “3”, the number of events included in the event group 610 is “4”, the number of events included in the event group 611 is “4”, and the number of events included in the event group 612 is “2”. Thus, the selection unit 106 selects the event group 610 and event group 611 as candidate groups 701. Note that the selection unit 106 may select, as the candidate group 701, an event group in which the number of event ranges 601 included in the event group is a predetermined ratio or more to the number of times of the estimation process of event ranges. Concretely, for example, when the predetermined ratio was set at 70% and the estimation process of event ranges was executed 10 times, the selection unit 106 selects, as the candidate group 701, an event group including seven or more event ranges. Thereby, since event ranges that do not present in the teaching data can be specified by a majority decision, while a fluctuation of estimation(inference) is being taken into account, it is possible to improve the possibility of adding only an omission in teaching data, which is not an estimation error of the trained model.

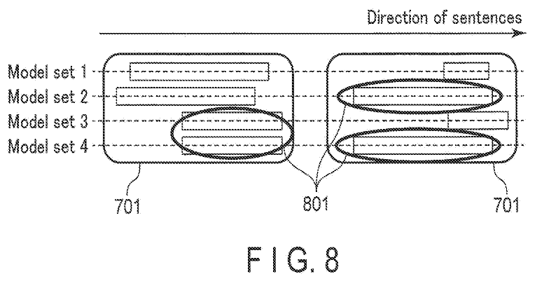

Next, an example of decision of an additional event will be described with reference to FIG. 8.

FIG. 8 illustrates the candidate groups 701 illustrated in FIG. 7. The decision unit 107 decides additional events from among the event ranges included in the candidate groups 701. In a method of deciding additional events, for example, the decision unit 107 decides, as additional events 801, a greatest number of event ranges 601 which are selected as event ranges having identical character sequences, among the event ranges belonging to the candidate group 701. For example, in the example of FIG. 8, in a first candidate group 701 (event group 610) in the direction of progress of sentences, event ranges 601 estimated in the model set 3 and model set 4 have identical character sequence ranges, and thus the number of identical event ranges that are selected is “2”. Since each of the event ranges estimated in the other model sets 1 and 2 does not have an identical range to the other event ranges in the first candidate group, the number of selected identical event ranges is “1” in regard to each of these event ranges. Thus, the decision unit 107 decides, as additional events 801, the event ranges estimated in the model set 3 and model set 4 in the first candidate group 701.

Similarly, in a second candidate group 701 (event group 611), event ranges 601 estimated in the model set 2 and model set 4 have identical character sequence ranges, and thus the number of selected identical event ranges is “2”. In addition, since the number of selected identical event ranges is “1” in regard to each of the event ranges of the other model set 1 and model set 3, the decision unit 107 decides, as additional events 801, the event ranges 601 estimated in the model set 2 and model set 4.

Note that, even in the case of an event range which is a target that meets the above-described condition of the decision method of an additional event, if the event range ends with an unnatural part of speech, for instance, a particle, or a special symbol such as a colon or a parenthesis, the event range may not be decided as the additional event. In addition, when a plurality of event ranges having no overlapping event ranges are present in upper ranks of numbers of overlapping event ranges in the candidate group, the decision unit 107 may decide the plurality of event ranges having no overlapping event ranges, as additional events 801, and at least one of the above decision methods may be used in combination.

Furthermore, when the addition unit 108 registers the additional event in the teaching data, the addition unit 108 may also register a weight for a sentence including the event range for which the event group was generated, with respect to each of sentences which constitute the document. For example, when an event group is generated, there is a possibility that a sentence including the event range belonging to the event group is a part to which a label was not given in the teaching data, and the reliability of the sentence is low as the teaching data. Thus, the addition unit 108 may give a lower weight to the sentence including the event range for which the event group was generated, than to the sentence including the event range which was given to the teaching data in advance. In addition, the label of the token may be weighted such that only the weight of the range of the additional event, not the weight of the entire sentence, may be lowered. Besides, weighting is performed such that the weights of the labels of all tokens constituting a certain sentence are lowered.

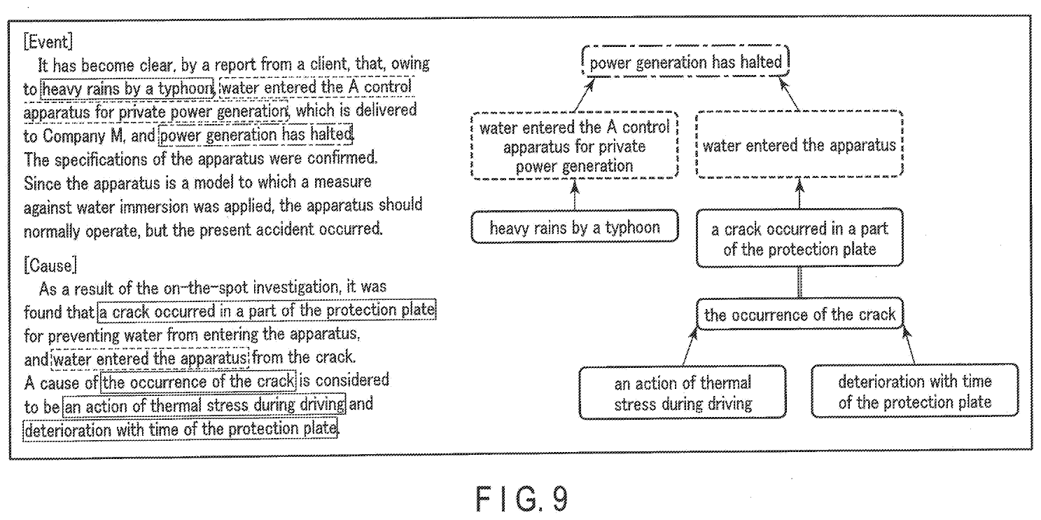

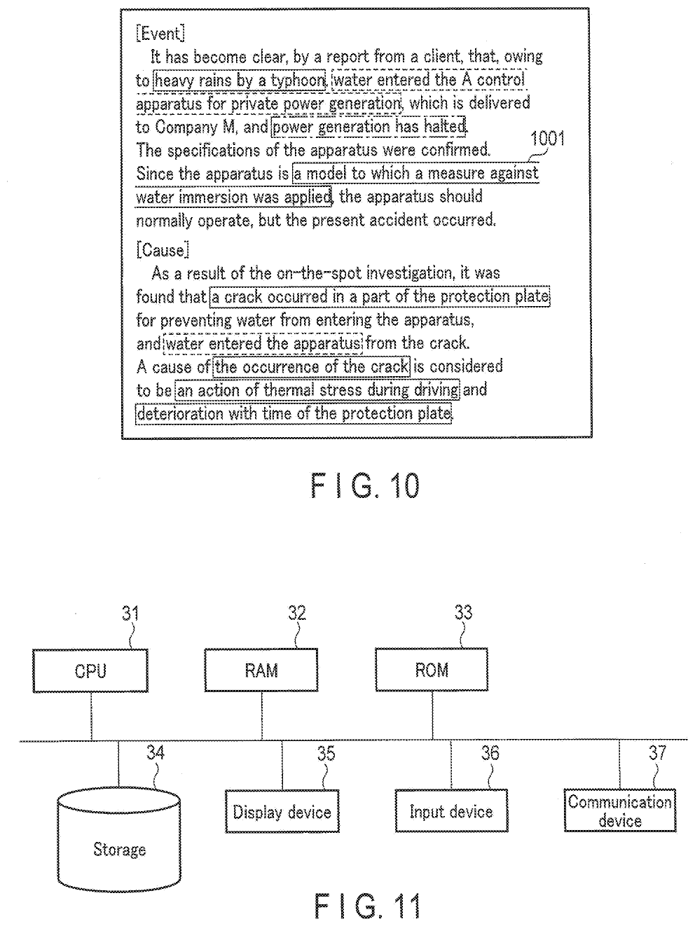

Next, referring to FIG. 9 and FIG. 10, a description will be given of an example of use of event ranges generated by the data generation apparatus 10 according to the embodiment.

A left part of FIG. 9 illustrates a document which is a processing target, and a case is assumed in which event ranges are already extracted like teaching data. The extracted event ranges are displayed in boxes. In this manner, so-called “sequence labeling”, in which event ranges are extracted from a target document, is performed. A right part of FIG. 9 is a graph illustrating a causal relationship of events. A relationship can be displayed by estimating the causal relationship of events.

FIG. 10 illustrates a case in which an additional event is added to the target document of the left part of FIG. 9 by the data generation apparatus 10.

A case is assumed in which the estimation process of event ranges is executed for the target document by the data generation apparatus 10 according to the embodiment, and an event range of “a model to which a measure against water immersion was applied” was added as an additional event 1001. In this manner, if the target document is teaching data, even when there is an omission of setting of an event range in the teaching data, the event range, to which a label should normally be given, can be added as the additional event 1001.

Note that the estimation result of the event range and the additional event may be used as target data for a keyword search, as well as for the estimation of the causal relationship, and can be applied to any purpose of use if there is a merit in extracting event ranges without an omission.

Note that the training unit 103 may generate a trained model by training the model by using updated teaching data which is updated by the addition of an additional event to existing teaching data. By training the model by using the updated teaching data, a trained model with a high recall can be generated, and the extraction of appropriate event ranges can be achieved.

Next, FIG. 11 illustrates an example of a hardware configuration of the data generation apparatus according to the above embodiment.

The data generation apparatus includes a CPU (Central Processing Unit) 31, a RAM (Random Access Memory) 32, a ROM (Read Only Memory) 33, a storage 34, a display device 35, an input device 36 and a communication device 37, and these components are connected by a bus. Note that the display device 35 may not be included in the hardware configuration of the data generation apparatus 10.

The CPU 31 is a processor which executes an arithmetic process and a control process, or the like according to programs. The CPU 31 uses a predetermined area of the RAM 32 as a working area, and executes various processes in cooperation with programs stored in the ROM 33 and storage 34, or the like. For example, The CPU 31 executes functions relating to each unit of the data generation apparatus 10 or the learning apparatus.

The RAM 32 is a memory such as an SDRAM (Synchronous Dynamic Random Access Memory). The RAM 32 functions as the working area of the CPU 31. The ROM 33 is a memory which stores programs and various information in a non-rewritable manner.

The storage 34 is a device which writes and reads data to and from a magnetic recording medium such as an HDD, a semiconductor storage medium such as a flash memory, a magnetically recordable storage medium such as an HDD (Hard Disc Drive), or an optically recordable storage medium. The storage 34 writes and reads data to and from the storage medium in accordance with control from the CPU 31.

The display device 35 is a display device such as an LCD (Liquid Crystal Display). The display device 35 displays various information, based on a display signal from the CPU 31.

The input device 36 is an input device such as a mouse and a keyboard, or the like. The input device 36 accepts, as an instruction signal, information which is input by a user's operation, and outputs the instruction signal to the CPU 31.

The communication device 37 communicates, via a network, with an external device in accordance with control from the CPU 31.

According to the above-described embodiment, by a plurality of different methods, a plurality of estimation processes of event ranges are executed for the document of teaching data, and an event group is generated based on an overlapping degree of event ranges obtained by the respective estimation processes. From the event group, an additional event, which is an event range to be added to the teaching data, is decided and registered in the teaching data. Thereby, data, to which a label is not given as the event range in the teaching data but a label of the event range should normally be given, can be added.

In addition, for example, if all event ranges, which are merely estimated in the trained models and are not present in the teaching data, are added as positive examples, the recall increases but there is a possibility of a simple estimation error, and it is possible that such event ranges are registered as noise data and the precision lowers. However, according to the embodiment, for example, by using k-fold cross validation, the estimation process of event ranges is executed multiple times by different trained model sets with respect to the document of the teaching data, and, by taking into account the overlapping degree of event ranges obtained by the respective trained model sets, it becomes possible to increase the probability that an event range with high certainty, which is not an estimation error, can be decided as an additional event.

As a result, the quality of the data set can be improved.

The instructions indicated in the processing procedure illustrated in the above embodiment can be executed based on a program that is software. A general-purpose computer system may prestore this program, and may read in the program, and thereby the same advantageous effects as by the control operations of the above-described data generation apparatus and learning apparatus can be obtained. The instructions described in the above embodiment are stored, as a computer-executable program, in a magnetic disc (flexible disc, hard disk, or the like), an optical disc (CD-ROM, CD-R, CD-RW, DVD-ROM, DVD±R, DVD±RW, Blu-ray (trademark) Disc, or the like), a semiconductor memory, or other similar storage media. If the storage medium is readable by a computer or an embedded system, the storage medium may be of any storage form. If the computer reads in the program from this storage medium and causes, based on the program, the CPU to execute the instructions described in the program, the same operation as the control of the data generation apparatus and learning apparatus of the above-described embodiment can be realized. Needless to say, when the computer obtains or reads in the program, the computer may obtain or read in the program via a network.

Additionally, based on the instructions of the program installed in the computer or embedded system from the storage medium, the OS (operating system) running on the computer, or database management software, or MW (middleware) of a network, or the like, may execute a part of each process for implementing the embodiment.

Additionally, the storage medium in the embodiment is not limited to a medium which is independent from the computer or embedded system, and may include a storage medium which downloads, and stores or temporarily stores, a program which is transmitted through a LAN, the Internet, or the like.

Additionally, the number of storage media is not limited to one. Also when the process in the embodiment is executed from a plurality of storage media, such media are included in the storage medium in the embodiment, and the media may have any configuration.

Note that the computer or embedded system in the embodiment executes the processes in the embodiment, based on the program stored in the storage medium, and may have any configuration, such as an apparatus composed of any one of a personal computer, a microcomputer and the like, or a system in which a plurality of apparatuses are connected via a network.

Additionally, the computer in the embodiment is not limited to a personal computer, and may include an arithmetic processing apparatus included in an information processing apparatus, a microcomputer, and the like, and is a generic term for devices and apparatuses which can implement the functions in the embodiment by programs.

What is claimed is:

1. A data generation apparatus comprising a processor configured to:
select an event group in which at least a part of a plurality of event ranges overlap, the event ranges being ranges of character sequences estimated by a plurality of different methods with respect to a document of teaching data and being different from ranges of character sequences defined with respect to the document; and
determine, from among the event group, an additional event which is an event range to be added to the teaching data.

2. The apparatus according to claim 1, wherein the processor selects, as the event group, the event ranges when an overlapping degree of the event ranges is a threshold or more.

3. The apparatus according to claim 1, wherein when a number of the event ranges which overlap each other is a threshold or more, the processor determines the event ranges as the additional event.

4. The apparatus according to claim 1, wherein the processor further configured to estimate an event range in the document, with respect to each of a plurality of different trained models trained by using the teaching data.

5. The apparatus according to claim 1, wherein the processor is further configured to divide the teaching data into a plurality of partial data;
train a model by using a part of the plurality of partial data, and to generate a trained model; and
estimate, by using the trained model, the event ranges in regard to a sentence corresponding to the other of the plurality of partial data,
wherein the generation of the trained model and the estimation of the event ranges are repeated such that the event ranges are estimated for each of the plurality of partial data.

6. The apparatus according to claim 5, wherein
Wherein the processor
generates a plurality of sets of the plurality of partial data by varying division positions of the teaching data,
generates a trained model set including the plurality of trained models with respect to each of the sets of the plurality of partial data, and
estimates the event ranges by using the trained model set with respect to each of the sets of the plurality of partial data.

7. The apparatus according to claim 1, wherein each of the event ranges estimated by the different methods are ranges which a plurality of users set for the document.

8. The apparatus according to claim 1, wherein a weight is given to each of sentences or tokens, which constitute the document.

9. A data generation method comprising:
selecting an event group in which at least a part of a plurality of event ranges overlap, the event ranges being ranges of character sequences estimated by a plurality of different methods with respect to a document of teaching data and being different from ranges of character sequences defined with respect to the document; and
determining, from among the event group, an additional event which is an event range to be added to the teaching data.

10. The method according to claim 9, wherein the selecting selects, as the event group, the event ranges when an overlapping degree of the event ranges is a threshold or more.

11. The method according to claim 9, wherein when a number of the event ranges which overlap each other is a threshold or more, the determining determines the event ranges as the additional event.

12. The method according to claim 9, further comprising estimating an event range in the document, with respect to each of a plurality of different trained models trained by using the teaching data.

13. The method according to claim 9, further comprising:
dividing the teaching data into a plurality of partial data;
training a model by using a part of the plurality of partial data, and to generate a trained model; and
estimating, by using the trained model, the event ranges in regard to a sentence corresponding to the other of the plurality of partial data,
wherein the generation of the trained model and the estimation of the event ranges are repeated such that the event ranges are estimated for each of the plurality of partial data.

14. The method according to claim 13, further comprising:
generating a plurality of sets of the plurality of partial data by varying division positions of the teaching data,
generating a trained model set including the plurality of trained models with respect to each of the sets of the plurality of partial data, and
estimating the event ranges by using the trained model set with respect to each of the sets of the plurality of partial data.

15. The method according to claim 9, wherein each of the event ranges estimated by the different methods are ranges which a plurality of users set for the document.

16. The method according to claim 9, wherein a weight is given to each of sentences or tokens, which constitute the document.

17. A learning apparatus comprising:
a processor configured to:
train a model by using updated teaching data in which the additional event generated by the data generation apparatus according to claim 1 is added to the teaching data; and
generate a trained model.
